(19) United States
(12) Patent Application Publication
(10) Pub. No.: US 2019/0217737 A1
(43) Pub. Date: Jul. 18, 2019

(54) AUTONOMOUS ROBOTIC CHARGERS AND ELECTRIC VEHICLE CHARGING SYSTEM

(71) Applicant: Nader Lotfy, Pasadena, CA (US)

(72) Inventor: Nader Lotfy, Pasadena, CA (US)

(21) Appl. No.: 16/250,373

(22) Filed: Jan. 17, 2019

Related U.S. Application Data
(60) Provisional application No. 62/619,068, filed on Jan. 18, 2018.

(51) Int. Cl. B60L 53/38; H02J 50/90; B60L 53/12; B60L 53/57; G05D 1/02; G06Q 10/02; G06Q 50/06

(52) U.S. Cl. CPC B60L 53/38; H02J 50/90; B60L 53/12; H02J 7/025; G05D 1/0231; G06Q 10/02; G06Q 50/06; B60L 53/57

(57) ABSTRACT

An autonomous robotic charger can include an onboard energy storage system, a navigation unit, a transportation unit, and a power exchange unit. The power exchange unit can be capable of i) charging energy to the onboard energy storage, from one or more external energy systems, and ii) discharging energy from the onboard energy storage system to one or more external energy systems.

### BACKGROUND

The present disclosure relates to the field of charging electric vehicles.

Electric Vehicles (EVs) are gaining popularity as modes of personal transportation, however, limiting factors and deficiencies remain, especially related to charging infrastructure and the installation thereof.

### SUMMARY

The following issues relate to the architecture of EV charging solutions and the way charging equipment is wired, mounted, and fixed to designated spaces. Public EV charging facilities typically include EV chargers, also known as Electric Vehicle Supply Equipment (EVSEs), located and mounted/fixed near a designated EV parking space. Parking structures can have one or more designated EV parking spaces, based on the forecasted user demand. Unfortunately, to accommodate EV charging, the current and future EV charging needs must be planned for and calculated at the time the parking structure/lot is built or retrofitted. Under this system, however, each EV charger is inconveniently confined to a designated space or spaces. Unfortunately, EV users can be shut-out of parking spaces during peak hours or other surges in use. Furthermore, to retrofit an existing structure or add new designated spaces, costly infrastructure must be built, for example, wire routing, trenching, cabling, mounting hardware, and more, all of which must typically conform to electrical codes.

The task of estimating current and future EV charging needs is difficult and error-prone, especially in a fast-growing market where the number of EVs is quickly changing. If the number of “EV Use Only” parking spaces are under estimated, there will be a risk of EV users not being to charge in an efficient matter. On the other hand, if the numbers are over estimated, the cost of installation increases, while EV designated spaces remain empty or underutilized.

Work-place charging suffers similar issues as well, with the added problem where employees driving EVs typically prefer to leave their EV in the same space for the entire work-day, even after the actual charging is finished, thereby unnecessarily blocking another potential user access to the charger. In this case, EV users/employees typically resort to scheduling schemes where they swap parking spots to ensure everyone gets access. This is an undesirable and inefficient solution because workers must spend additional time coordinating. In addition, the workers must inconveniently move their vehicles to another parking space during their work day.

Multi-Unit Dwellings (MuD), for example, condominiums, townhomes, and apartment buildings are also problematic. Currently, specific parking spaces are associated with a particular unit of the development. This brings up the question of who is responsible for the cost of installation and what happens when the EV user moves out of the building. Furthermore, what happens when an existing user decides to purchase an EV but their space does not have the infrastructure. Again, costly construction and retrofitting ensues.

The present disclosure relates to charging infrastructures for EVs, and a system and apparatus that addresses one or more of the problems described herein. The present disclosure mitigates the problems described herein, relating to large public parking structures, work-place charging, and parking facilities in MuDs.

The present disclosure relates to decoupling the relationship between i) extraction of energy (from an electrical power grid) and ii) dispensing that energy to the EV. Such decoupling includes both time and space.

The system, according to the present disclosure, can extract the energy from the grid at a time A, and then later, at a time B, use that energy to charge an EV. Similarly, the system can extract energy from the grid at a location Y and then dispense the energy to an EV at a different location Z.

The systems and apparatuses described herein provide EV users the ability to park their EVs in any spot within a parking structure/lot. The charging equipment will travel to the vehicle and perform the needed charging function anywhere in the parking structure.

According to a first aspect, an autonomous robotic charger is described. The robotic charger includes: an onboard energy storage system; a navigation unit; a transportation unit; and a power exchange unit. The power exchange unit is capable of charging and discharging energy to and from the onboard energy storage to and from one or more external energy systems (e.g., an electric power grid, a battery pack of an electric vehicle, or other electrical energy system that is external to the robotic charger). For example, the power exchange unit can charge the onboard energy storage from an electrical power grid and discharge energy from the onboard energy storage unit to a battery pack of an electrical vehicle. In another example, the onboard energy storage can be charged from one electrical vehicle and discharge energy to the electrical power grid. In another example, the onboard energy storage can charge the onboard energy storage from one vehicle and discharge energy to another electrical vehicle. The external energy storage system that the onboard energy storage is charged from can be the same or different energy storage system that the onboard energy storage system discharges to.

According to a second aspect, a control station is disclosed having one or more computing devices, configured to: communicate with one or more robotic chargers according to claim 1; receive a charge request; select a robotic charger to be dispatched; select an EV to be charged; and command the selected robotic charger to charge the selected EV.

The autonomous and mobile robotic charger alleviates the risk of installing too many or too few EVSEs at designated parking spaces because the portable charging equipment or portable EVSE can move from space to space, in this manner, a single portable EVSE can service many EVs.

Furthermore, if the need grows or shrinks over time, additional portable EVSEs can be purchased, deployed, allocated to a busier location in parking structure, and/or removed from service. Furthermore, such an architecture can provide flexibility, such that planners temporarily employ more portable EVSEs in a parking structure during peak times, for example, the holiday shopping season in a mall.

Furthermore, this greatly reduces installation complexity and cable routing, mounting, and building code conformance, all of which can be costly.

Providing portable charging equipment, however, presents additional challenges and corresponding solutions identified and disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 shows a block diagram for the robotic charger.

FIG. 2 shows a block diagram for the charging depot.

FIG. 3 shows a block diagram of the control station.

FIG. 4 shows communication between the control station, charging depot, users, and robotic chargers.

FIG. 5 shows an embodiment of the robotic charger with an EV.

FIG. 6 shows an embodiment of the robotic charger with a charging depot.

FIG. 7 shows a simplified body of a robotic charger.

### DETAILED DESCRIPTION

Descriptions herein relating to dimensions, such as shapes, ratios, lengths/widths/heights, and more, are approximations and are intended to include a range, for example, within a 5%, 10%, or 20% margin of error, as understood by one skilled in the art.

### Definitions

“Autonomous”, as used herein, means capable of movement and self-transportation without continuous input from a person.

“Coil”, as used here, means an electric conductor that is wound into a coil, capable of electromagnetic coupling.

“Robotic” or “robot”, as used herein, to relate to an autonomous, self-mobile machine, capable of moving from one location to another and perform operations automatically.

“Computing device” or “processor”, as used herein, includes any processor or microprocessor based system, or electronic equivalent, capable of storing and executing machine instructions.

“Wireless”, as used herein to describe a robotic charger, relates to the robotic charger not having an electrical chord, cable, or connection fixed between the robotic charger and another object, for example, a power source, outlet, or grid.

### System Description

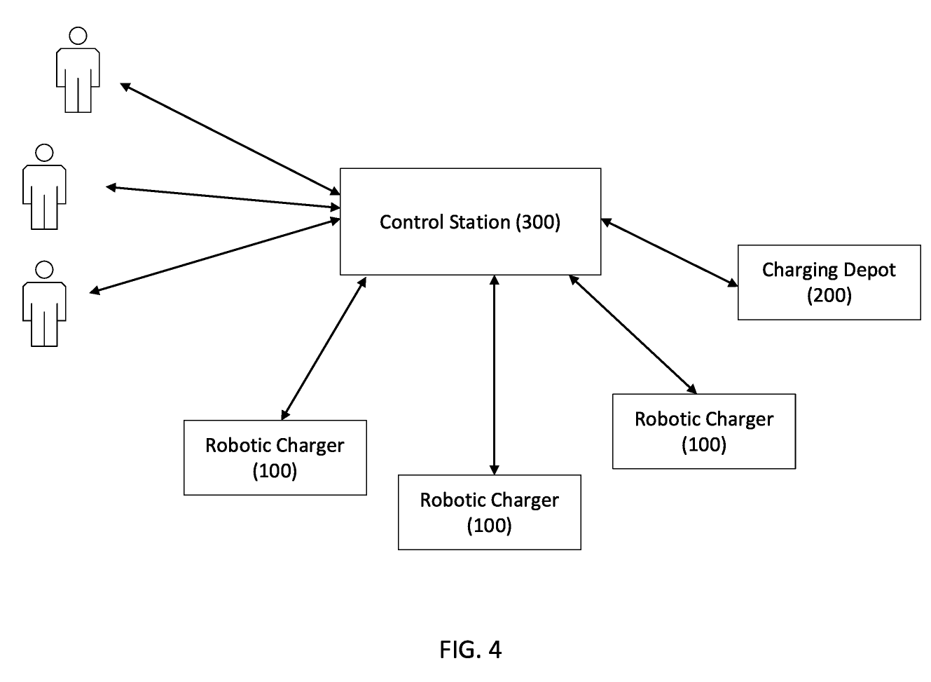

As discussed, various challenges arise in known EV charging systems. An EV charging system employing autonomous robotic chargers with onboard energy storage addresses various problems described. As shown in FIG. 4, such a system can include one or more autonomous robotic chargers (100), one or more control stations (300), and one or more charging depots (200), located at a parking structure/lot.

The control stations (300) can be configured to receive, from one or more users, charge requests. Upon receiving a charge request, a control station can schedule charge requests and command robotic chargers to charge EVs. The control stations can also command the robots (100) to charge their onboard energy storage at the one or more charging depots (200).

The parking structure can include parking spaces with unique labels, to advantageously map the location of a user's EV. For example, each parking space can have a unique number. The EV or the EV user can then communicate this parking space to a control station, in a charge request.

The disclosed system arguably has inherent present inefficiencies compared to known systems. For example, since the charging of the robot's on-board energy storage and the dispensing of that energy to the parked EV take place at different physical locations, this results in spatial inefficiency, i.e. taking up more space.

Furthermore, robotic charger acts as an intermediary charger, resulting in an overall increased charge and discharge time, because the total time to extract the energy from the grid and dispense that energy to the EV could be twice as long as charging the EV directly from the grid.

There is also the added inefficiency in the usage of energy since the power gets processed twice as opposed to just once as in the case of direct charging.

These seeming inefficiencies, however, can be absorbed by the users, in return for a much more flexible charging system, that both allows the extraction of energy from the grid at the most opportune time when energy costs are low, and the grid is not at its peak usage time. Similarly, charging depots can be located within a parking structure to minimize the cost installations and trenching. In addition, EV charging can be provided to any parking space. Similarly, this system also allows for expansion in the future with minimal cost impact on the initial investment.

### Robotic Charger

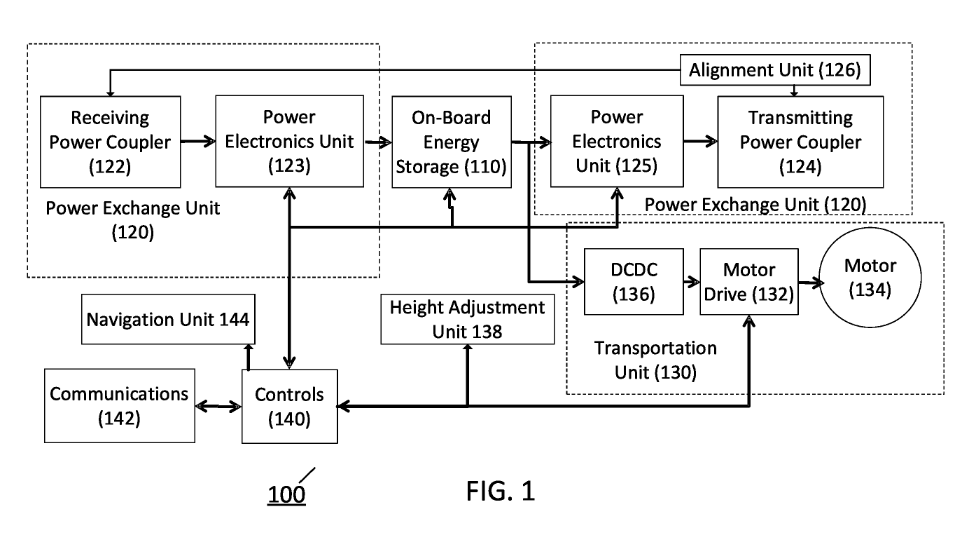

As shown in FIGS. 1, 5 and 6, a portable EV charging solution can include a robotic charger (100, 600). The robotic charger can be an autonomous robot, not requiring continuous human control or monitoring. An autonomous robot advantageously automates the charging process and obviates the need for a dedicated operator.

The robotic charger can include one or more processors, computing devices, or electronic equivalents thereof, capable of storing and performing machine instructions.

Referring to FIG. 1, the robotic charger can include an energy storage 110, for example, a battery pack. The energy storage can be 12 kWhr or greater. Preferably, the energy storage can be sized to roughly match the average EV battery pack size, for example, 20 kWhr to 100 kWhr, or more. Advantageously, a single robotic charger can at least provide a full charge to an EV without having to recharge itself.

The energy storage can comprise second-use batteries to reduce cost and better utilize existing resources to reduce the environmental impact of producing new batteries.

The robotic charger can have a means to charge its own onboard energy storage and a means to dispense the energy from its onboard energy storage to an EV. In other words, the robotic charger can have a power exchange unit (120), capable of charging its onboard energy storage and discharging the stored energy into a vehicle. In this manner, the robotic charger and the onboard energy storage beneficially decouples the process of taking energy from the grid from the process of dispensing energy to the EV.

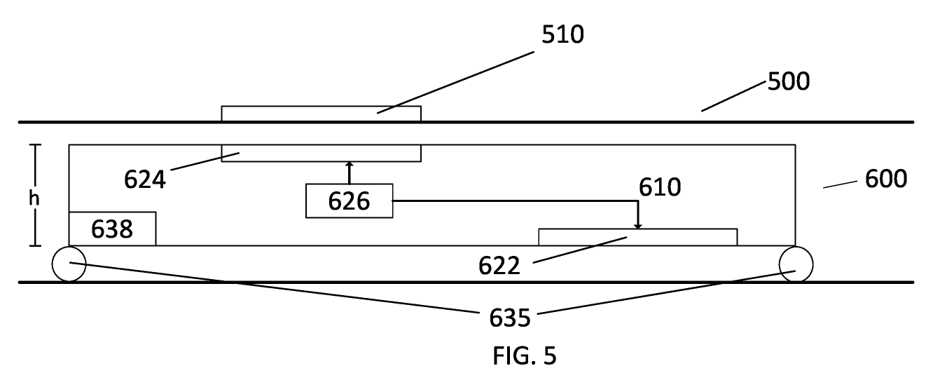

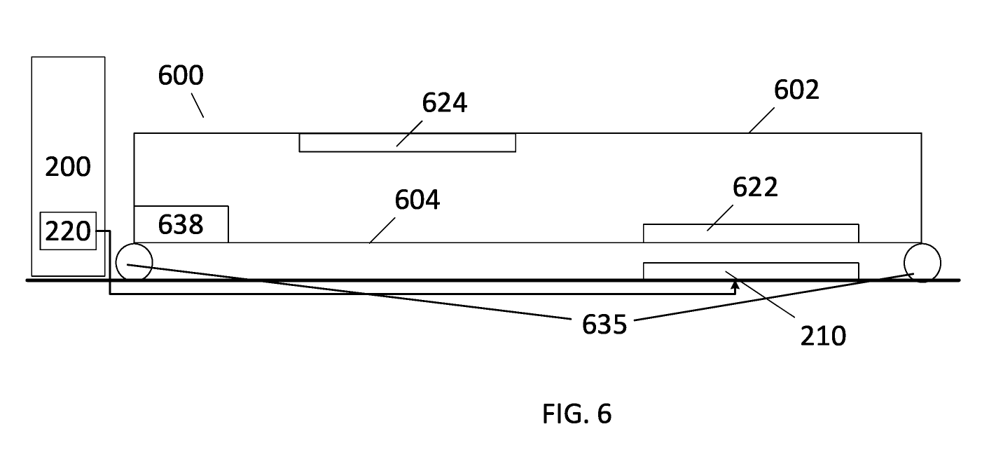

For example, the power exchange unit can include a receiving power coupler 122. The receiving power coupler can include or consist of a receiving coil (shown as 622 in FIGS. 5 and 6) to absorb wireless energy/power, through electromagnetic coupling, from a transmitting coil located in the charging depot.

The robotic charger can thereby convert the energy from the receiving coil with an associated power electronics unit (123), having power electronic switching circuits and components, and store the energy in the robotic charger's energy storage (110).

Similarly, the power exchange unit can include a transmitting power coupler (124). The transmitting power coupler can include or consist of a transmitting (shown as 624 in FIGS. 5 and 6) coil with associated power electronics unit (125) to discharge the energy stored in the onboard energy system, to an EV's receiving coil.

Components for the power electronics units, DCDC charger, and motor driver described herein can include, for example, MOSFETs, IGBTs, transformers, passive components such as resistors, capacitors and inductors, and diodes. Components can also include integrated circuits, gate-drive circuits, programmable logic circuits such as FPGAs and CPLDs as well as dedicated DSPs and other microprocessors. The components can be arranged according to known topologies, for example, boost, buck, buck-boost, half bridge, full bridge, combinations thereof, or other topologies known in the art. Different topologies and components can be selected based on the particular application, for example, the grid voltage, the battery voltage, maximum power transfer, power loss, and other considerations.

Advantageously, the transmitting coil and receiving coil can be the same coil, thereby reducing the parts, size, and cost of the robotic charger. In such a case, the charging depot can have a bottom-facing transmitting coil, elevated similar to an EV's receiving coil, located to align and couple with a top-facing coil of the robotic charger, wherein the robotic chargers top-facing coil and the robotic charger's power electronics are configured to charge (receive) and discharge (transmit) energy.

Alternatively, as shown in FIGS. 5 and 6, the transmitting coil (624) and the receiving coil (622) can be separate coils to reduce the complexity of the power conversion electronics and to accommodate the locations of the EV receiving coil and the transmitting coil of the depot.

For example, FIG. 5 show a robotic charger (600) having a transmitting coil (624) located towards a first surface of the robotic charger. The first surface of the robotic charger can be located on a top surface (602) of the robotic charger. Advantageously, the robotic charger's transmitting coil can thereby align with, and electro-magnetically couple with, an EV receiving coil (510) located at a bottom surface of the EV (500) (for example, an SAE J2954 Vehicle Assembly (VA).

Furthermore, FIG. 6 shows the robotic chargers receiving coil (622) can be located at a second surface of the robotic charger. The second surface can be, for example, located on a bottom facing surface (604) of the robotic charger. In this manner, the robotic charger's receiving coil can thereby align with and electro-magnetically couple with a charging depot's transmitting coil (210), for example, a SAE J2954 Ground Assembly (GA) located on a floor surface.

The robotic chargers can have an alignment unit (626, 126) to align the robot's charging coils with mating coils. For example, the alignment unit can align the robotic charger's transmitting coil with the EV's receiving coil such that the EV's coil is directly above the robot's coil. Alignment would be in X, Y, Z as well as rotational. The alignment unit can include cameras; position sensors; RF sensors; RFID position sensors; mechanical alignment/positioning pins, members, stops, or other couplings; magnetic locking members, or other comparable sensors and/or alignment mechanisms now known or later developed.

The alignment unit can also be integral to the robotic charger's transmitting coil, where the robotic charger is configured to generate a weak magnetic field to be sensed by magnetic sensors to help align the transmitting and receiving coil.

As shown in FIG. 5, the robotic charger can have a means to slide under a parked EV and position the transmitting coil in alignment with the receiving coil of the EV for efficient wireless charging. In this regard, the robotic charger can have a body (610) with a substantially flat shape (i.e. a height h is substantially smaller than the other two dimensions), which provides a low, nearly sheet-like or pancake-like, profile.

The robot can have a low height h, capable of being determined by one skilled in the art, based on an EV's ground clearance. For example, the height h can be less than 7 inches. More preferably, the height h can be less than 5 inches, and even more preferably, the height h can be less than 4 inches. In one aspect, the robotic charger can have a body height that is at least lower than the ground clearance of a tall EV (e.g., 7 inches), average EV (e.g., 5 inches), or lowest EV (e.g., 4 inches).

In addition, the robot can include a height-adjustment unit (138, 638). The height-adjustment unit can include actuators, robotic legs, and/or other known height adjustment mechanisms, to adjust the robot's height to accommodate for variations in ground clearance between vehicles and to improve the efficiency of the charging between the transmitting coil of the robot and the receiving coil of the EV. Similarly, the height-adjustment unit can raise the bottom of the robot to provide clearance over the transmitting coil of the depot and accommodate for variances in a profile height of such a transmitting coil. In this regard, the height adjustment unit may be especially beneficial and advantageous because the transmitting coil of the depot is not necessarily flat or level with the ground of the parking structure.

Therefore, the robot can be substantially flat and self-adjusting in height. to accommodate self-charging on a top-facing depot coil (below the robot); and discharging to a bottom-facing EV coil (above the robot), especially advantageous and beneficial because heights can vary in both the depot and the EV, thereby only providing a narrow size-window to accommodate for both.

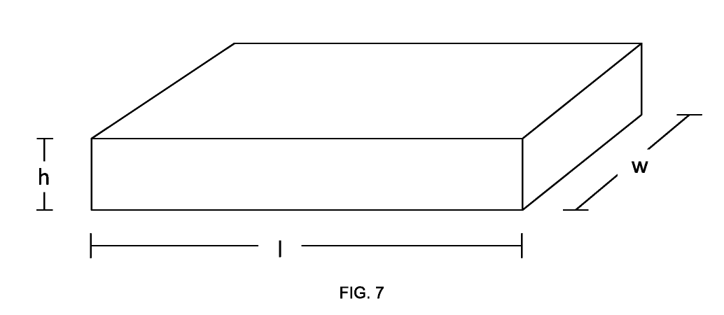

As shown in FIG. 7, the body (610) of the robot can have a width w and length l such that the width and/or length is less than the distance between the vehicle's front and rear tires, and/or less than the distance between the two front tires or the two rear tires. In other words, the robotic charger can advantageously have a height h, a width w, and a length l, such that the robot can maneuver underneath the car, from side to side, or front to back.

As shown in FIG. 1, the robotic chargers can have a transportation unit (130) to provide mobility. For example, the robot can include one or more wheels (635), robotic legs, a propulsion system (for example, a motor drive (132), a motor (134), and/or a DCDC converter (136)), a braking system, and/or other comparable known means of transportation to enable mobility of the robot. The transportation unit can include one or more processor based systems, computing devices, or electronic equivalents thereof, capable of storing and performing machine instructions.

The robotic charger's propulsion system can connect to and use the onboard stored energy to provide propulsion power and navigate throughout the structure, thereby obviating the need for a separate energy supply for the robotic charger's transportation.

Alternatively, or additionally, the robotic charger's propulsion system can have a dedicated power supply for a more modular architecture.

Alternatively, or additionally to the transmitting and/or receiving coils, the receiving and transmitting power couplers (122, 124) can include or consist of conventional plug-in connectors. Plug in connectors can be advantageous because they will conform to existing standards for plug-in receptacles on existing EVs in the market. Traditional plug-in connectors, however, may require human interaction to mate the plug with the receptacle, and therefore, charging in this case may lack full automation.

In one embodiment, the robotic charger can have a receiving coil to charge the onboard energy, however, the charger can have a plug for an EV user or attendant to plug into the vehicle for charging. This quasi-autonomous model still provides the flexibility of mobile-autonomous chargers that can travel about and obviates the need for costly construction and retrofitting. However, this embodiment can advantageously charge vehicles that only support plug-in charging.

Furthermore, the robotic charger's transmitting power coupler 124 can include both, a transmitting plug, and a transmitting coil, to accommodate a range of EVs having either receptacles or receiving coils.

In one embodiment, the robotic charger can have a conductive plug on its top surface to engage and plug into a conductive receptacle on the bottom surface of the EV. This embodiment would allow this conductive coupling mechanism to be autonomous.

The robotic chargers can have a means to safely maneuver through the parking structure to enable travel between the charging depot, EVs, and other locations.

In other words, the robotic chargers can have a navigation unit (144) configured to autonomously navigate inside parking structure and to avoid obstacles including people, cars, and other robots. The navigation unit can include one or more processor based systems, computing devices, or electronic equivalents thereof, capable of storing and performing machine instructions.

For example, the mobility unit can include a Lidar based system to provide the required mapping required to enable safe maneuvering inside parking structure. Such a system can include a sensor, such as a laser and rotating mirrors, or an equivalent sensing device now known or later developed.

The navigation unit can be configured to locate parked EVs in the parking structure based on location data provided by EV driver (for example, a parking space number). The control station and/or the robotic chargers can receive payment information verification data and EV identification data, and use this data to verify the accuracy of location info provided by EV driver to ensure the proper EV is being charged.

In other words, the control station and/or the robotic charger can advantageously verify that the car that the robotic charger is about to charge matches the payment and EV data related to the charge request.

The robotic charger can include a communication (142) and control unit (140). The communication and control unit can include a transmitter and/or a receiver, and a computing device, configured to communicate with one or more control stations, receive commands to charge EVs, and to send information to the control stations. Information can include, for example, energy status, how much energy has been delivered to an EV, how much energy is left in the onboard energy storage, onboard diagnostics, whether the robotic charger is available to perform a charge or is currently occupied, and additional information.

Communication units described herein can utilize Wifi, bluetooth, ZigBEE, 3G, GSM, NFC, RFID, or other equivalent technologies.

Although FIGS. 5 and 6 do not show each and every feature of the robotic charger described in FIG. 1, the features shown in FIG. 1 can be present in the embodiment shown in FIGS. 5 and 6 and vice versa.

In one aspect, a method, performed by an autonomous robotic charger having an onboard energy storage system, a navigation unit, a transportation unit; and a power exchange unit; includes: charging energy from an electric power grid to the onboard energy storage system through a receiving coil of the power exchange unit; and discharging energy to an electric vehicle through a transmitting coil of the power exchange unit.

### Control Station

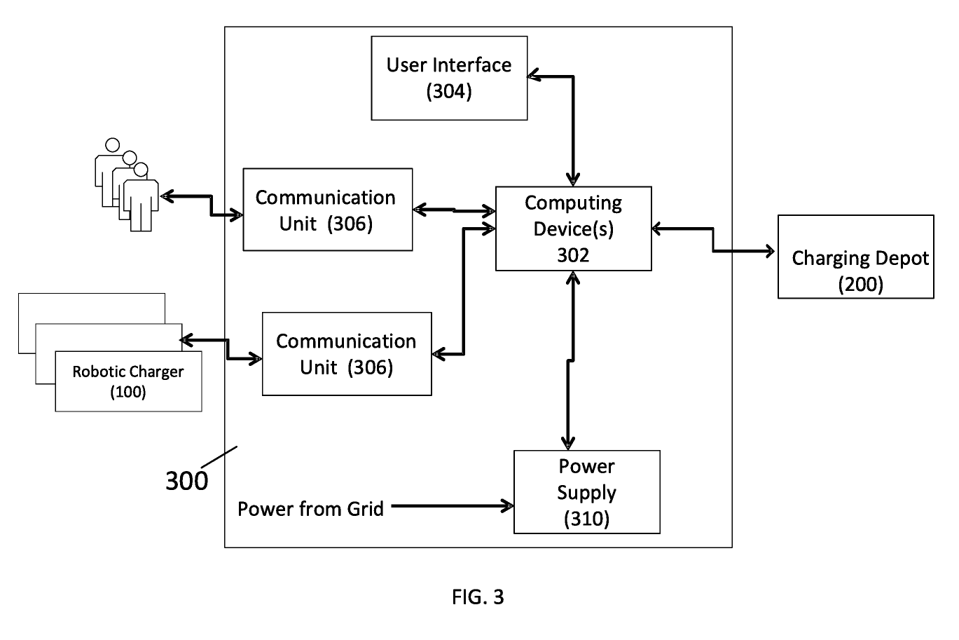

Referring to FIG. 3, the control station 300 can include one or more computing devices (302), configured to receive, and aggregate the incoming charging requests, track the available robots, manage and schedule the charging of the robotic chargers' onboard energy storage at the charging depot, and manage the dispatching of the robotic chargers to charge the EVs.

The control station can include a kiosk having a user interface (304), for example, a touch screen or display and buttons. The control station can be configured to communicate with and receive user inputs from the kiosk and/or mobile devices or other comparable computing devices. The control station can be powered from the grid through a power supply (310).

The control station can include one or more communication units (306), having one or more transmitters and/or receivers and one or more computing devices. The communication units can be configured to transmit and receive data the control station and kiosks, mobile applications, and robotic chargers.

The control station can be configured to receive one or more charge requests, for example, through a user interface, or through a communication from a remote kiosk, or from an EV's onboard computer, or from a mobile application.

The control station can be configured to command a single robot to charge an EV if the onboard energy of the robot is greater than or equal to the energy the EV is requesting. If the onboard energy is less than that of the charge request, the control station can command one or more additional robots to help charge the EV, one at a time, until the EV's energy request is satisfied.

In this manner, the control station can advantageously satisfy EVs with larger battery packs that require more energy than available from a single robot.

When multiple robots are deployed to charge an EV sequentially, the charging mini-sessions can be done one after another, or, with a break in between.

Based on the one or more charge requests, the control station can be configured to send one or more commands to the robotic charger to a) select a robotic charger (out of a fleet of chargers) to be dispatched and b) select an EV to charge, and c) command the selected charger to charge the selected EV.

For example, if all the robotic chargers are in-use (e.g., charging other EVs), the control station can select and schedule a charger to perform the charging function based on a first-come first-serve basis. The control station can inform the EV driver of the schedule and update the EV driver of the charge status of the vehicle, for example, through a display on a kiosk, or remotely, through an SMS message or a phone.

The control station can manage a schedule for charging EVs, through one or more algorithms.

For example, the control station can be configured to receive a charge request from an EV user, either automatically, through communications with vehicles driving in, or manually, through a kiosk, or remotely, through a call.

The control station can be configured to take instant charge requests, where the EV user would like a charge as soon as possible. The control station can schedule multiple requests based on the number of robots available, the total available stored energy on board robots, and the total number of charge requests. For example, the control station can be configured to manage a queue of charge requests. The charge requests can be queued on a first-come first-serve basis or the control station can prioritize some requests over others based on tiered pricing or other schemes.

In addition, the control station can be configured to receive a reservation request ahead of time, and reserve a robotic charger and/or an amount of energy for the requester at a specified time.

Advantageously, the reservation feature provides EV users assurance that their EV will be charged at the parking structure at a planned time, regardless of how busy the parking structure may be.

In other words, the control station can have one or more computing devices that are configured to communicate with one or more robotic chargers; receive a charge request from a kiosk, a mobile device, or other comparable system, the charge request corresponding to an EV; selecting which charge request to service (if multiple requests are present); selecting a robotic charger to be dispatched to charge the EV; and commanding the selected robotic charger to charge the EV.

Thus, as described above, a method, performed by a control station, can include: communicating, with one or more autonomous robotic chargers; receiving a charge request to charge an electric vehicle (EV); selecting a robotic charger to be dispatched; selecting an EV to be charged; and commanding the selected robotic charger to charge the selected EV.

In one aspect, the method can further include: receiving a reservation request for a specified future time; and reserving an autonomous robotic charger or an amount of energy for a requested.

### Charging Depot

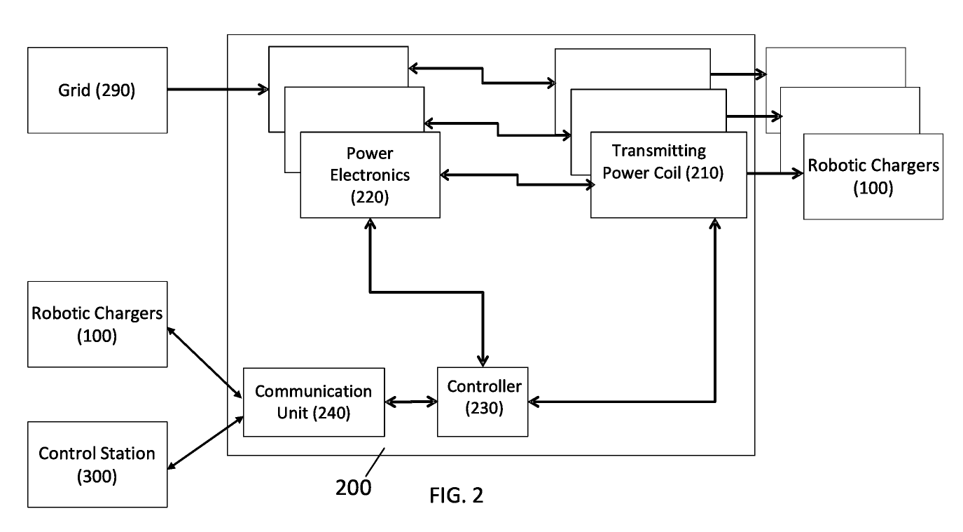

Referring to FIG. 2, the charging depot (200) can include one or more transmitting coils (210) and corresponding power electronics units (220). The charging depot's transmitting coils be ground assemblies, located at a ground surface, conforming to J2954, as shown in FIG. 6. The charging depot can connect to a grid (290) or other large power source. As described above, the charging depot's transmitting power coil (210) can couple with a receiving coil (622) on a robotic charger to charge the robotic chargers onboard energy storage.

Advantageously, the charging depot location can be optimized to reduce cost of installation and could potentially be very close to the utility power entry of the building, thus eliminating need to do extensive trenching in pre-existing structures.

Alternatively, the charging depot can provide a direct contact-based connection for robots to connect to, for example, a plug and receptacle connections.

The charging depot can include a communication unit (240) to communicate with one or more robotic chargers (100) and one or more control stations (300) and a controller (230) configured to supervise and control the power electronics and process messages from the communication unit (240).

### Charge Process

An embodiment of the current system includes a control station, configured to receive EV driver calls and reservations for a charge session. The control station reserves the required robot(s) and required energy. Alternatively, EV driver can simply just drive into parking structure without prior reservation.

Once an EV user finds an available parking space and parks his/her EV, the user identifies the space/location by number, and enters that information into a mobile charging application or a kiosk.

The mobile charging application or kiosk is configured to receive and send to the control station: the type of energy source desired (for example, solar, wind or coal); pricing options; how much energy is desired or what State of Charge the EV should be charged to; and how long the EV will be available to be charged.

The control station is then configured to identify robot(s) available to perform the charging function and dispatches them to the specified location/parking space.

The robotic chargers: maneuver in the parking structure towards the EV; slide underneath the EV and perform alignment between the robotic chargers transmitting coil and the EV's receiving coil; begin the charging session; if the energy required by an EV charge request that exceeds that of the energy stored in the robot, the control station can command other robots in a sequential fashion to supply required energy to the EV.

When charging session is finished, the robotic chargers slide out from underneath EV, and move on to either charge another EV or head back to the charging depot to recharge their on-board batteries.

In one aspect, as described herein, an autonomous robotic charger includes: an onboard energy storage system; a navigation unit; a transportation unit; a power exchange unit; and a processing system having at least one hardware processor, the processing system coupled to a memory programmed with executable instructions that, when executed by the processing system, perform operations including charging energy from an electric power grid (e.g., a utility grid) to the onboard energy storage system; and discharging energy to an electric vehicle through the power exchange unit.

In addition, the performed operations can further include navigating between the electric power grid and the electric vehicle autonomously by controlling the transportation unit based on navigation data (e.g., one or more directions, a location of the robotic charger, a location of an electric vehicle, a location of an obstacle, a direction, and a location of an electric power grid) from the navigation unit. The charging and the discharging operations can be performed in response to receiving a command from a control station.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. An autonomous robotic charger comprising:
an onboard energy storage system;
a navigation unit;
a transportation unit; and
a power exchange unit,
wherein the power exchange unit is capable of i) charging energy to the onboard energy storage, from one or more external energy systems, and ii) discharging energy from the onboard energy storage system to one or more external energy systems.

2. The autonomous robotic charger according to claim 1, further comprising:
a communication unit; and
a control unit,
wherein the communication unit and control unit are configured to receive a command to charge an electric vehicle (EV).

3. The autonomous robotic charger according to claim 1, further comprising a body having a substantially flat-shape, wherein a height of the body is at least lower than the ground clearance of a tall, average, or lowest EV.

4. The autonomous robotic charger according to claim 1, wherein the power exchange unit includes:
a transmitting coil; and
a receiving coil.

5. The autonomous robotic charger according to claim 4, wherein:
the transmitting coil is located at a top-facing surface of the robotic charger, and
the receiving coil is located at a bottom-facing surface of the robotic charger.

6. The autonomous robotic charger according to claim 1, further comprising:
a top-facing surface;
a bottom-facing surface; and
a height-adjustment unit, wherein the height adjustment unit is configured to adjust a height of the top-facing surface and/or the bottom-facing surface.

7. The autonomous robotic charger according to claim 1, further comprising:
one or more alignment units, configured to align the transmitting coil and/or the receiving coil of the robotic charger to a receiving and/or transmitting coil of the one or more external energy systems.

8. The autonomous robotic charger according to claim 1, wherein the navigation unit includes a lidar system having one or more sensors.

9. The autonomous robotic charger according to claim 1, wherein the transportation unit includes a propulsion system connected electrically to the onboard energy storage system, configured to draw power from the onboard energy storage system and convert the power for self-transport.

10. A control station for robotic chargers, comprising one or more computing devices, configured to:
communicate with the one or more autonomous robotic chargers according to claim 1;
receive a charge request;
select a robotic charger to be dispatched;
select an electric vehicle (EV) to be charged; and
command a selected robotic charger to charge a selected EV.

11. The control station of claim 10 is further configured to:
receive a reservation request for a specified future time,
reserve an autonomous robotic charger and/or reserve an amount of energy for a requester at a specified future time.

12. An autonomous robotic charger comprising:
an onboard energy storage system;
a navigation unit;
a transportation unit;
a power exchange unit; and
a processing system having at least one hardware processor, the processing system coupled to a memory programmed with executable instructions that, when executed by the processing system, perform operations including
charging energy from an electric power grid to the onboard energy storage system; and
discharging energy to an electric vehicle through the power exchange unit.

13. The autonomous robotic charger according to claim 12, wherein the performed operations further include navigating between the electric power grid and the electric vehicle autonomously by controlling the transportation unit based on navigation data from the navigation unit.

14. The autonomous robotic charger, according to claim 12, wherein the charging and the discharging operations are performed in response to receiving a command from a control station.

15. The autonomous robotic charger according to claim 12, further comprising a body having a substantially flat-shape, wherein a height of the body is at least lower than the ground clearance of a tall, average, or lowest EV.

16. The autonomous robotic charger according to claim 12, wherein the power exchange unit includes:
a transmitting coil; and
a receiving coil.

17. The autonomous robotic charger according to claim 12, wherein:
the transmitting coil is located at a top-facing surface of the robotic charger, and
the receiving coil is located at a bottom-facing surface of the robotic charger.
